(19) United States
(12) Patent Application Publication
(10) Pub. No.: US 2008/0178427 A1
(43) Pub. Date: Jul. 31, 2008

(54) HINGE MECHANISM FOR MOTOR VEHICLE

(75) Inventor: Ke-Chien Chen, Taipei (TW)

Correspondence Address: SCHMEISER, OLSEN & WATTS, 22 CENTURY HILL DRIVE, SUITE 302, LATHAM, NY, 12110, US

(73) Assignee: STARTECH CO., LTD., TAIPEI CITY (TW)

(21) Appl. No.: 11/972,184

(22) Filed: Jan. 10, 2008

(30) Foreign Application Priority Data
Jan. 26, 2007 (TW) 096201634

(51) Int. Cl. E05F 1/08

(52) U.S. Cl. 16/277

(57) ABSTRACT

A hinge mechanism for motor vehicle includes a base having two parallelly extended brackets; a supporting arm having a proximal end located between the two brackets and provided with a shaft hole having a diametrically extended stop rib; a pivot shaft extended through the two brackets with a longitudinally slotted end engaged with the stop rib on the supporting arm; a restoring spring located outside one of the two brackets to connect at two ends to the base and the pivot shaft to deform when the pivot shaft is rotated and thereby produces an elastic restoring force; and a damper located outside the other bracket to connect to the slotted end of the pivot shaft and form a resistance to the rotating pivot shaft, so that a saddle or a trunk lid connected to the supporting arm may be pivotally lifted and closed at a moderate speed.

### FIELD OF THE INVENTION

The present invention relates to a hinge mechanism for motor vehicle, and more particularly to a hinge mechanism for motor vehicle that has reduced volume and can be easily assembled and disassembled for maintenance and adjustment.

### BACKGROUND OF THE INVENTION

FIG. 1 shows a first conventional hinge mechanism 6 for motor vehicle mentioned in Taiwan Patent Publication No. 547400, which is mainly used to connect a saddle to a motorcycle body. The hinge mechanism 6 includes a base 61 mounted to a motorcycle body and having first and second side plates 62. A shaft 63 has an end fixedly connected to a lower portion of a first ribbed arm 64a, and another free end extended through the first and the second side plate 62. The free end of the shaft 63 is provided with an inward longitudinally extended slot 65. A wound restoring spring 66 and a damper 67 are mounted on the shaft 63 between the two side plates 62 to connect to the slot 65. A sleeve 68 is mounted around a section of the free end of the shaft 63 sideward projected from the second side plate 62, and a second ribbed arm 64 is connected at a lower portion to and around the sleeve 68. A C-ring 69 is tightly mounted around the shaft 63 in front of the sleeve 68 to hold the sleeve 68 in place, preventing the sleeve 68 and the second ribbed arm 64 from separating from the shaft 63. The two ribbed arms 64, 64a are then connected to an underside of the motorcycle saddle. When the saddle is unlocked, an elastic force of the restoring spring 66 automatically pivotally lifts the saddle. The damper 67 provides a resistance to slow the speed at which the saddle is lifted.

In the above-described hinge mechanism 6, the restoring spring 66 and the damper 67 are subject to allowance errors during manufacturing thereof. As a result, saddles assembled to motorcycles via the hinge mechanism 6 could not be always lifted at a consistent speed, and it is uneasy to adjust the hinge mechanism 6 to thereby adversely affect the quality of the motorcycles.

FIG. 2 shows another conventional hinge mechanism 60 disclosed in Taiwan Patent Publication No. 547400 that is generally structurally similar to the hinge mechanism 6 of FIG. 1 but omits the sleeve 68 and the C-ring 69, and includes a shaft 630 having a screw hole 631 provided at one side of the slot 65, and a second ribbed arm 640 provided with a shaft hole 641 having a diametrically extended stop rib 642 corresponding to the slot 65 on the shaft 630. Whereby, when the shaft 630 is extended through the second ribbed arm 640 via the shaft hole 641, the slot 65 is engaged with the stop rib 642 to enable the ribbed arm 640 to rotate along with the shaft 630. And, a screwing element 632 may be threaded through the screw hole 631 to press against another inner side of the slot 65, such that the second ribbed arm 640 is prevented from separating from the shaft 630, and the slot 65 may be expanded for the shaft 630 to contact with and press against the restoring spring 66 and the damper 67 at different tightness and thereby adjust the speed at which the saddle is lifted.

In the above two conventional hinge mechanisms 6, 60 for motor vehicle shown in FIGS. 1 and 2, the restoring spring 66 and the damper 67 are mounted on the base 61 between the two side plates 62, and two lateral ends of the base 61 are sideward extended from the two side plates 62 by a certain distance to serve as two connecting sections for mounting the base 61 to the body of the motorcycle. As a result, a relatively large width must be kept between the two side plates 62, causing the base 61 to have an overall volume that can hardly be reduced to thereby occupy more space, and be made with more material. Meanwhile, when it is necessary to repair the restoring spring 66 or the damper 67, the shaft 63, 630 must be removed from the base 61 to disassemble almost the whole hinge mechanism 6, 60, which would no doubt cause inconveniences to the user and increase the repair cost. Moreover, since there are two ribbed arms 64, 640, 64a for connecting to the underside of the saddle, the hinge mechanism 6, 60 requires increased material cost and is not economical for use.

It is therefore tried by the inventor to develop an improved hinge mechanism for motor vehicle, so as to eliminate the drawbacks in the prior art.

### SUMMARY OF THE INVENTION

A primary object of the present invention is to provide a hinge mechanism for motor vehicle, which has restoring spring and damper located outside two brackets of a base to effectively reduce the space occupied by the base.

Another object of the present invention is to provide a hinge mechanism for motor vehicle, which allows easy disassembling of restoring spring and damper thereof for convenient maintenance and adjustment at reduced cost.

To achieve the above and other objects, the hinge mechanism for motor vehicle according to the present invention includes a base having two parallelly extended first and second brackets; a supporting arm having a proximal end located between the first and second brackets and provided with at least one shaft hole having a diametrically extended stop rib; a pivot shaft extended through a middle section of the first and second brackets, and provided on at least a second end corresponding to the second bracket with an inward longitudinally extended slot for engaging with the stop rib on the supporting arm, so that the pivot shaft is connected to and rotatable along with the supporting arm; a restoring spring located outside the first bracket to connect at two ends to the base and the pivot shaft, and being able to deform and produce an elastic restoring force when the pivot shaft is rotated; and a damper mounted to an outer side of the second bracket and connected to the second end of the pivot shaft to form a resistance to the rotating pivot shaft.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a conventional hinge mechanism for motor vehicle;

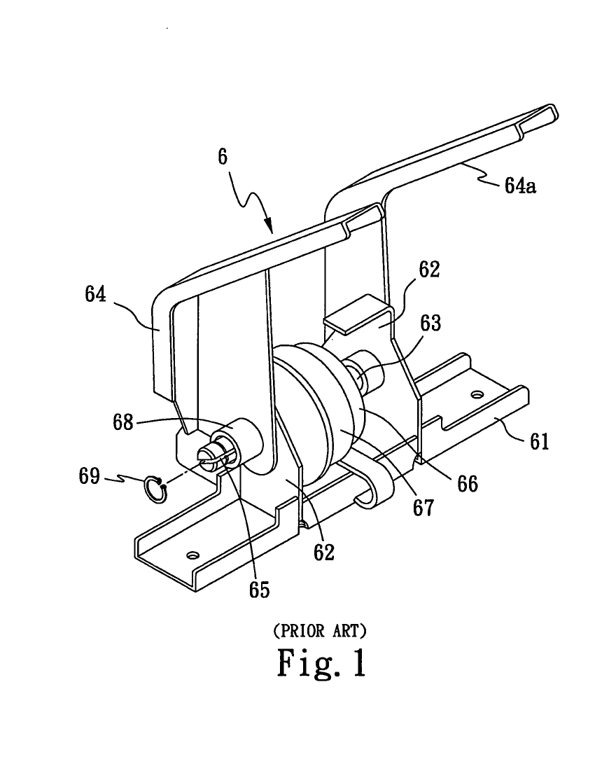

FIG. 2 is a partially exploded perspective view of another conventional hinge mechanism for motor vehicle;

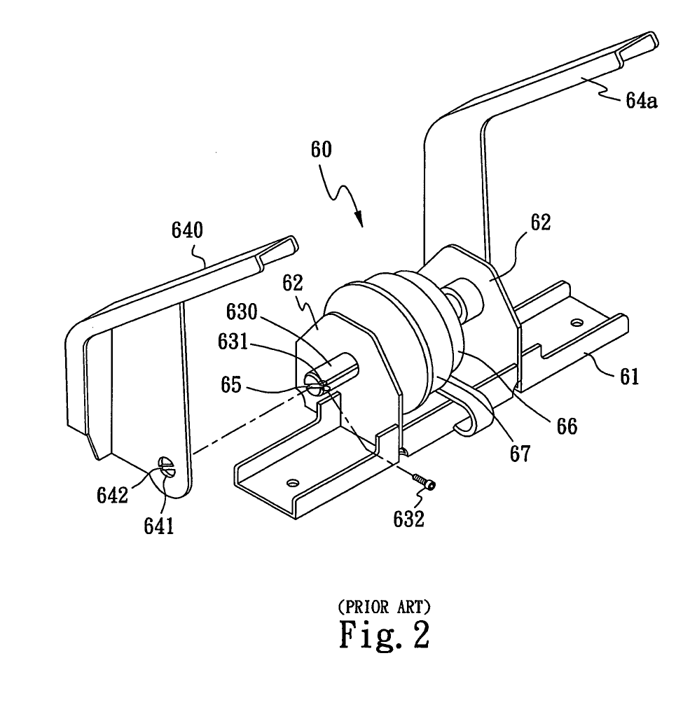

FIG. 3 is an exploded perspective view of a hinge mechanism for motor vehicle according to a first embodiment of the present invention;

FIG. 4 is an assembled view of FIG. 3;

FIG. 5 is a sectioned front view of FIG. 4;

FIG. 6 shows the hinge mechanism according to the first embodiment of the present invention is used on a motorcycle to connect a saddle to the body of the motorcycle, wherein the saddle is in a locked position;

FIG. 7 shows the motorcycle saddle of FIG. 6 in a lifted position;

FIG. 8 is an exploded perspective view of a hinge mechanism for motor vehicle according to a second embodiment of the present invention;

FIG. 9 is an assembled view of FIG. 8;

FIG. 10 shows the hinge mechanism according to the second embodiment of the present invention is used on a car to connect a trunk lid to a trunk;

FIG. 11 shows the hinge mechanism of FIG. 10 has been mounted to the car to connect the trunk lid to the trunk;

FIG. 12 shows the state of the hinge mechanism of the present invention when the trunk lid is in a lifted position; and

FIG. 13 shows the state of the hinge mechanism of the present invention when the trunk lid is in a closed and locked position.

### DETAILED DESCRIPTION OF THE PREFERRED EMBODIMENTS

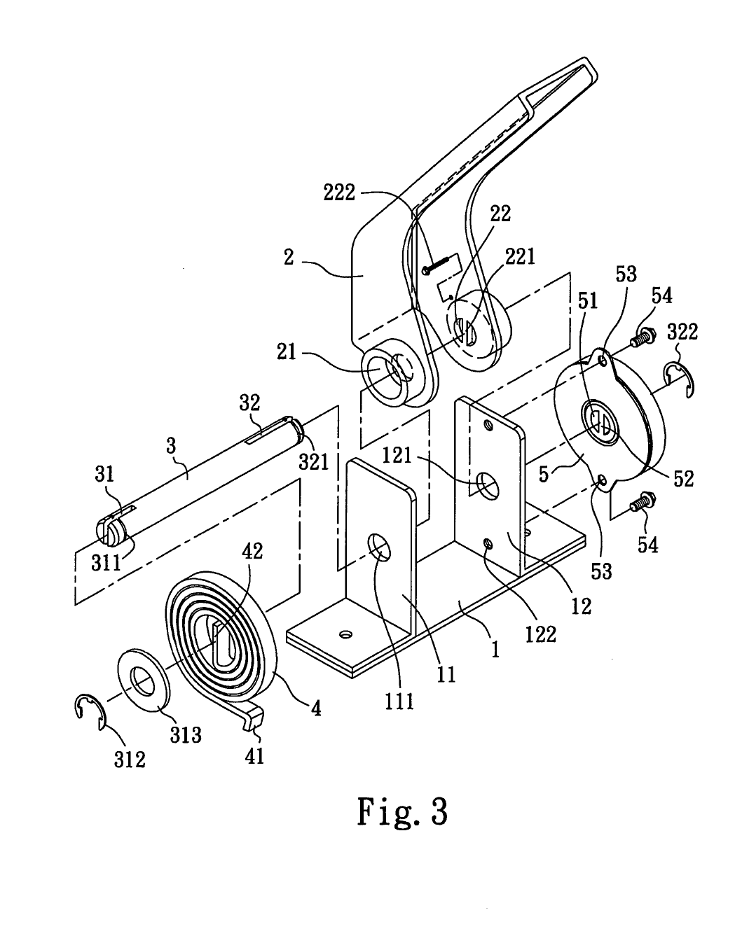

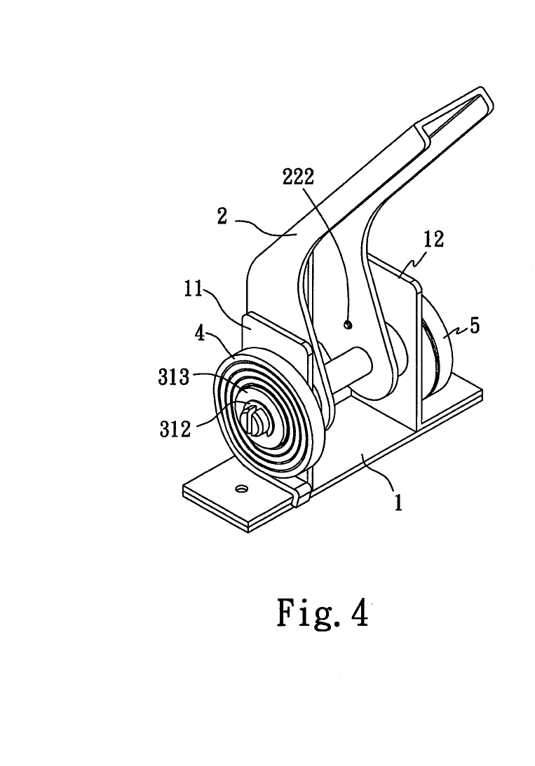

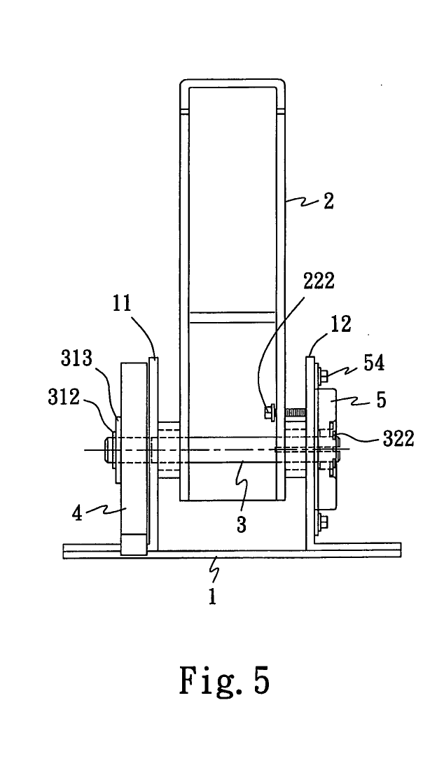

Please refer to FIGS. 3 and 4 that are exploded and assembled perspective views, respectively, of a hinge mechanism for motor vehicle according to a first embodiment of the present invention, and to FIG. 5 that is a sectioned front view of FIG. 4. As shown, the present invention mainly includes a base 1, a supporting arm 2, a pivot shaft 3, a restoring spring 4, and a damper 5.

The base 1 includes two parallelly extended brackets 11, 12. The two brackets 11, 12 are provided near a middle section with a sideward opening 111, 121 each. Wherein, the bracket 12 is further provided at two opposite sides of the sideward opening 121 with at least one screw hole 122 each.

The supporting arm 2 is bent near a middle section by a predetermined angle, and has a proximal end formed into two spaced lugs that forward extend to fitly locate between the two brackets 11, 12. The two lugs of the supporting arm 2 are provided with a shaft hole 21, 22 each. Wherein, the shaft hole 22 has a stop rib 221 diametrically extended across the shaft hole 22. An adjusting element 222 is movably provided on one of two side walls of the supporting arm 2 to interfere with the bracket 12 (or 11). Through the interference of the adjusting element 222 with the bracket 12, there is an increased friction between the adjusting element 222 and the bracket 12 to achieve the purpose of adjusting a moving speed of the supporting arm 2 relative to the base 1.

The pivot shaft 3 is provided at two opposite ends with an inward longitudinally extended slot 31, 32, and around the longitudinal slots 31, 32 with an annular groove 311, 321, respectively. The pivot shaft 3 is extended through the two sideward openings 111, 121 on the base 1 and the shaft holes 21, 22 on the supporting arm 2 to engage the longitudinal slot 32 with the stop rib 221 in the shaft hole 22, so that the supporting arm 2 is rotatably connected to the base 1 via the pivot shaft 3, and the pivot shaft 3 is rotatable along with the supporting arm 2. When the pivot shaft 3 has been assembled to the base 1 and the supporting arm 2, the two longitudinal slots 31, 32 are respectively located outside the two brackets 11, 12 of the base 1.

The restoring spring 4 is spirally wound and provides a restoring elasticity when it is deformed. The restoring spring 4 is located outside the bracket 11, and has an outer end formed into a hook portion 41 for hooking to a bottom of the base 1, and an inner end bent into a flat portion 42 for engaging with the longitudinal slot 31 on the pivot shaft 3. A washer 313 is mounted on the pivot shaft 3 at an outer side of the restoring spring 4, and a C-ring 312 is engaged with the annular groove 311 formed around the longitudinal slot 31, so as to hold the restoring spring 4 in place and prevent the same from moving out of the pivot shaft 3.

The damper 5 is mounted to an outer side of the bracket 12 of the base 1, and provided along an outer periphery with a plurality of mounting holes 53, via which bolts 54 are extended into the screw holes 122 on the bracket 12 to fixedly connect the damper 5 to the base 1. The damper 5 is formed at a center with a round through hole 51 corresponding to the sideward opening 121 on the bracket 12; and the round through hole 51 has a diametrically extended stop rib 52 for engaging with the longitudinal slot 32 when the damper 5 is mounted to an end of the pivot shaft 3 at the outer side of the bracket 12. With the stop rib 52 engaged with the longitudinal slot 32, the damper 5 is connected to and forms a resistance to the pivot shaft 3 when the latter is rotated. A C-ring 322 is mounted in the annular groove 321 at the end of the pivot shaft 3 to cooperate with the C-ring 312 at the other end to prevent the pivot shaft 3 from sliding sideward to separate from the base 1.

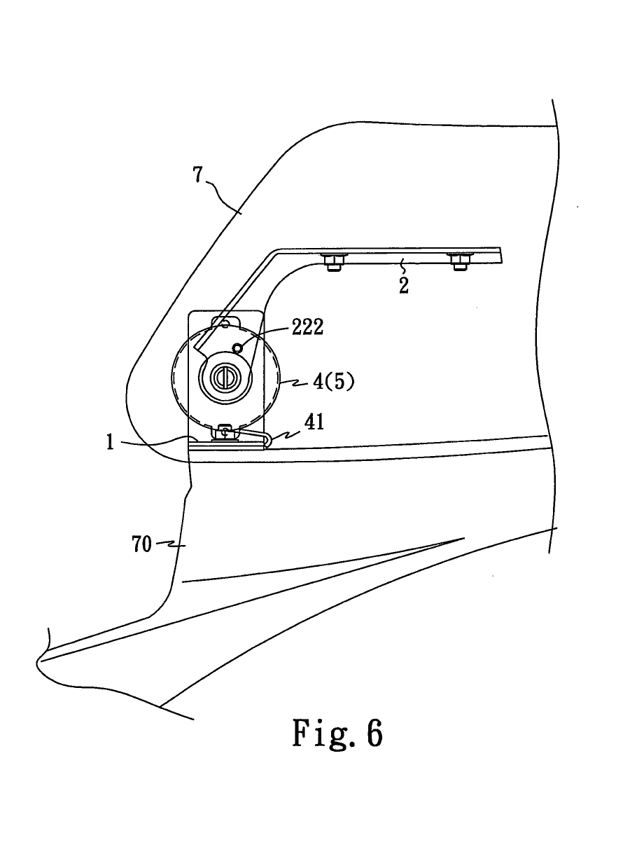

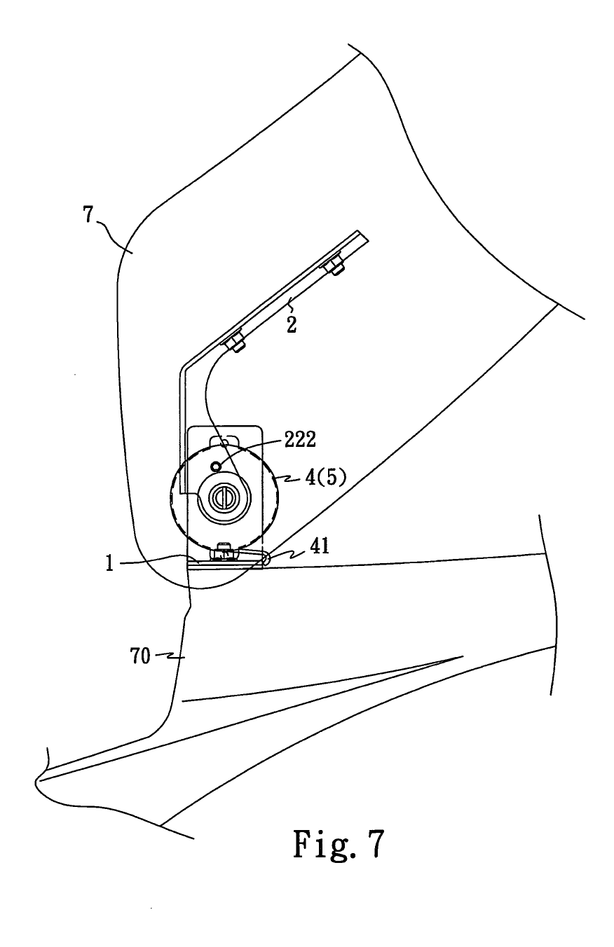

Please refer to FIGS. 6 and 7 that show the hinge mechanism according to the first embodiment of the present invention is used to connect a saddle 7 to a body 70 of a motorcycle. In this application, the base 1 is fixedly connected to the body 70 of the motorcycle near a lower front of the saddle 7, and the supporting arm 2 fixedly connected at a distal end to an underside of the saddle 7. When the saddle 7 is locked to close onto the motorcycle body 70, as shown in FIG. 6, the restoring spring 4 is deformed and in a wound-up state. And, when the saddle 7 is unlocked and in a free state, an elastic restoring force of the restoring spring 4 automatically lifts the saddle 7. Meanwhile, the damper 5 enables the saddle 7 to be lifted at a moderate speed.

In the above-described first embodiment, the restoring spring 4 and the damper 5 are respectively mounted to the outer side of the first and the second bracket 11, 12. With this design, a distance between the two brackets 11, 12 may be effectively reduced. Moreover, since the spaces located outside the two brackets 11, 12 are initially reserved for connecting the base 1 to the motorcycle body 70, the restoring spring 4 and the damper 5 mounted in these spaces would not occupy any additional space in the hinge mechanism, but help in effective utilization of the limited space on the base 1. When it is necessary to maintain or repair the hinge mechanism, simply dismount the C-ring 312 to disassemble the washer 313 and the restoring spring 4 from the pivot shaft 3 and the base 1. Alternatively, the bolts 54 and the C-ring 322 may be dismounted from the bracket 12 and the pivot shaft 3 to enable disassembling of the damper 5 from the pivot shaft 3 and the base 1 easily. It is completely not necessary to remove the pivot shaft 3 from the base 1 for the purpose of maintaining or repairing the hinge mechanism. Therefore, the hinge mechanism of the present invention may be conveniently maintained without the need of separating the parts thereof from one another.

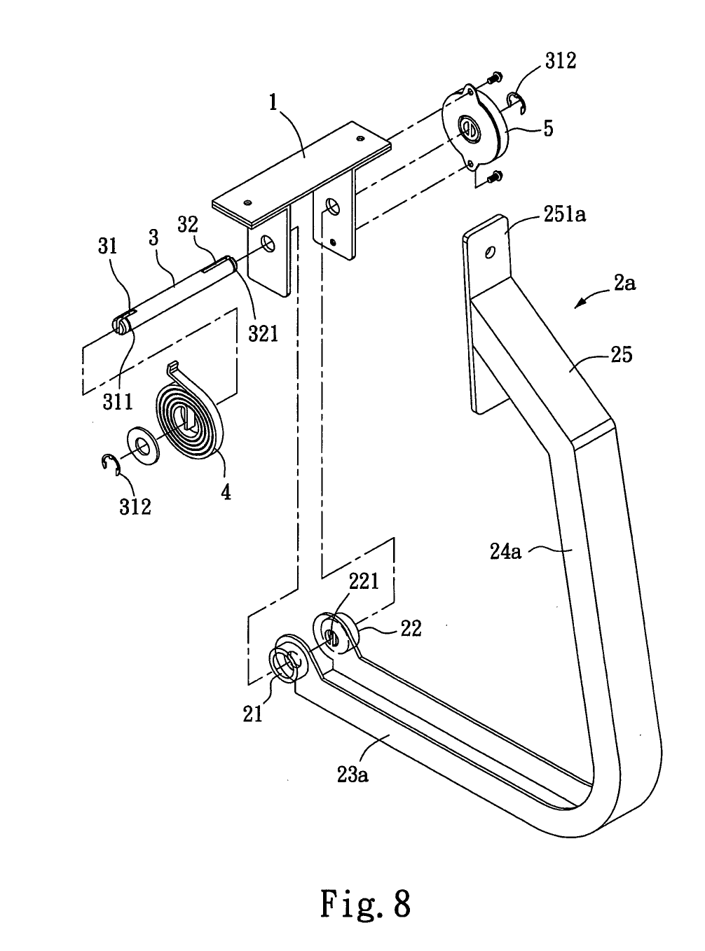

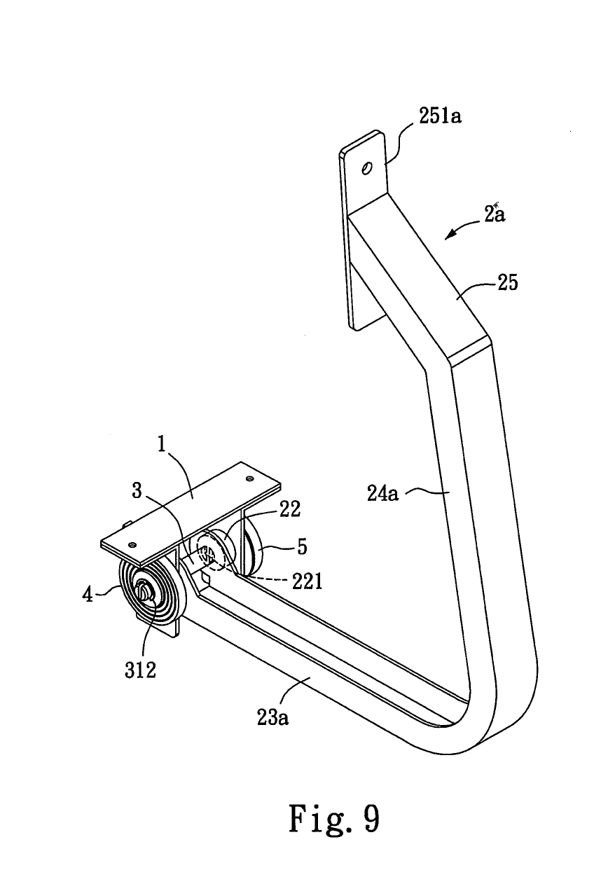

FIGS. 8 and 9 are exploded and assembled perspective views, respectively, of a hinge mechanism according to a second embodiment of the present invention. The second embodiment is structurally similar to the first embodiment but includes a supporting arm 2a consisting of three sequentially connected sections, namely, an extension section 23a, a bent section 24a, and an inclined section 25. The inclined section 25 is provided at a free end with a mounting plate 251a. The shaft holes 21, 22 are provided at a free end of the extension section 23a. As in the first embodiment, the supporting arm 2a is pivotally turnably connected to the base 1 by extending the pivot shaft 3 through the shaft holes 21, 22; and the restoring spring 4 and the damper 5 are separately mounted to two outer sides of the base 1 to interfere with the longitudinal slots 31, 32 on the pivot shaft 3. Thereafter, two C-rings 312 are separately engaged with the annular grooves 311, 321 formed around the longitudinal slots 31, 32 on the pivot shaft 3, so as to hold the restoring spring 4 and the damper 5 in place and prevent the same from moving out of the pivot shaft 3.

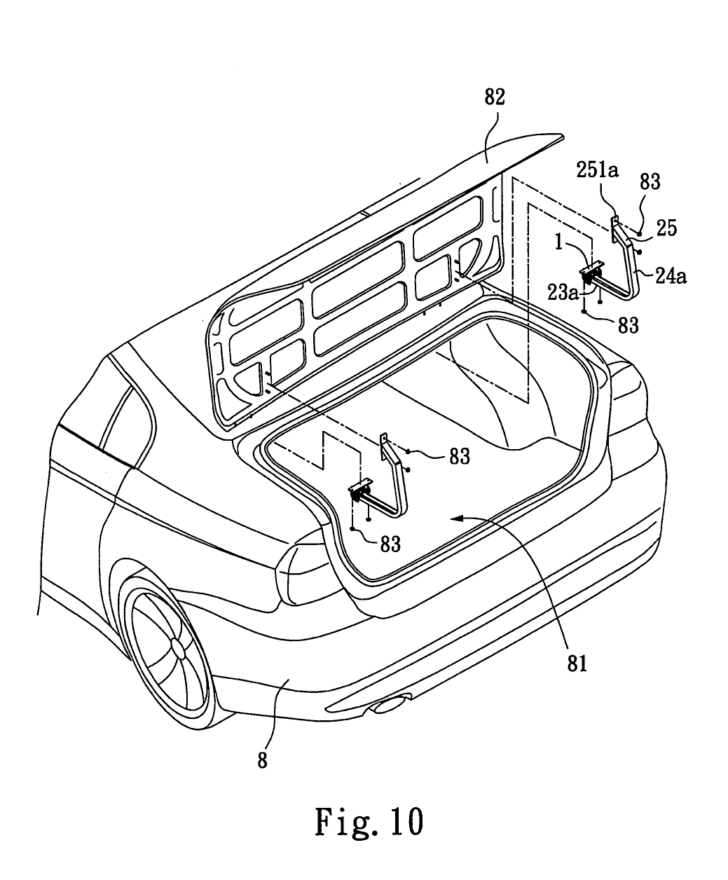

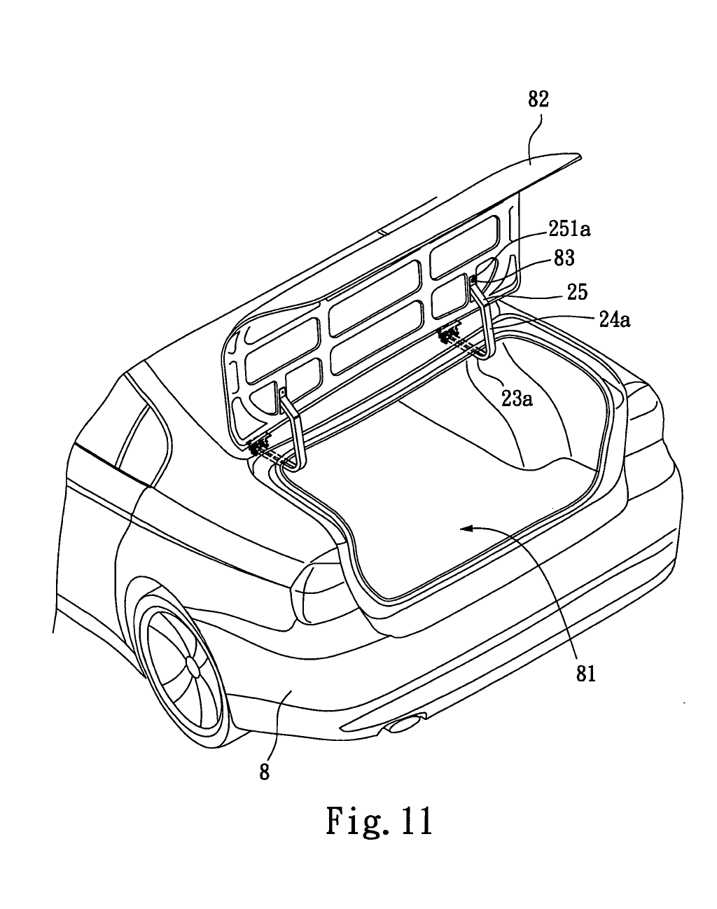

FIGS. 10 to 13 show the hinge mechanism according to the second embodiment of the present invention is used on a car 8 of any type to connect a trunk lid 82 to a trunk 81. Of course, the hinge mechanism in the second embodiment may also be used on a car to connect other parts, such as an engine lid, that are used to openably close a space. Please refer to FIGS. 10 and 11 that are exploded and assembled views, respectively, showing the mounting of the hinge mechanism of the second embodiment to the car 8. As shown, the base 1 and the mounting plate 251a at the free end of the supporting arm 2a are respectively fixedly mounted to a top of the trunk 81 and an inner side of the trunk lid 82 using fastening elements 83. A user may use only one set of the hinge mechanism to connect the trunk lid 82 to the trunk 81 at a middle position thereof, or use two sets of the hinge mechanism to connect the trunk lid 82 to the trunk 81 at two laterally spaced positions, depending on actual need in practical use and cost control.

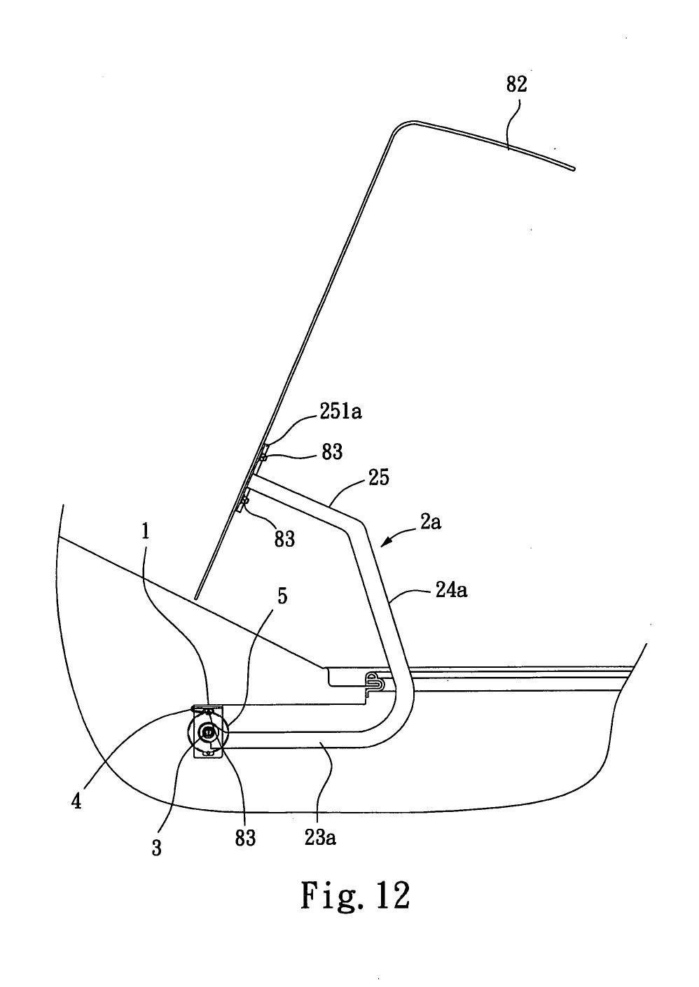

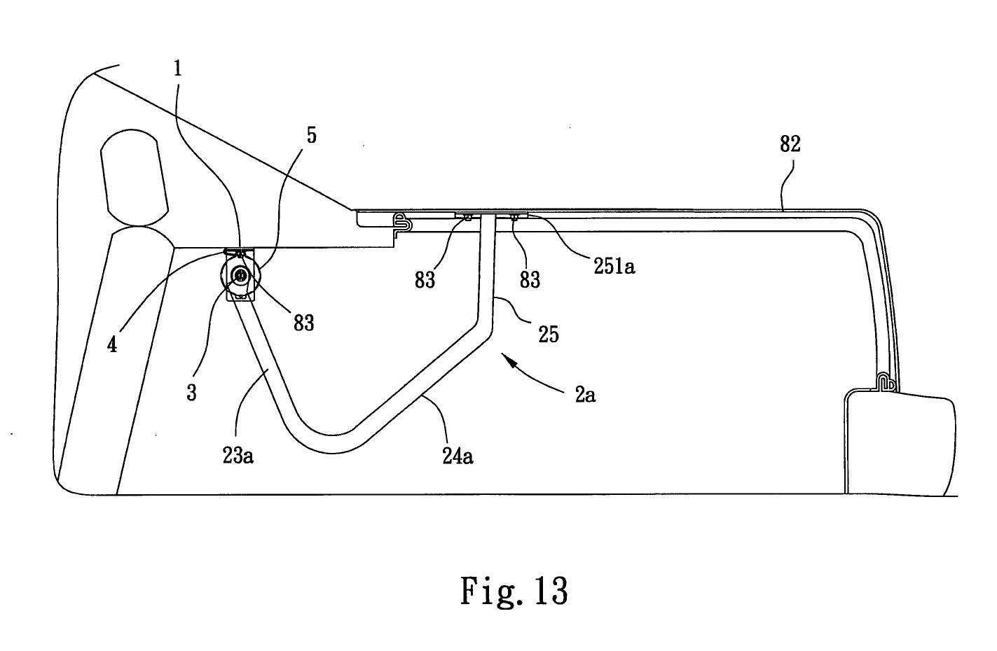

Please refer to FIG. 13 along with FIG. 9. When the trunk lid 82 is locked to close onto the trunk 81, the supporting arm 2a is compressed by the trunk lid 82 to thereby rotate the pivot shaft 3, so that the restoring spring 4 is wound up into a deformed state. And, when the trunk lid 82 is unlocked, as shown in FIG. 12, the restoring spring 4 is released to a free state, and an elastic restoring force of the restoring spring 4 automatically lifts the trunk lid 82. Meanwhile, the damper 5 limits the trunk lid 82 to move open at a moderate speed.

With the above arrangements, the hinge mechanism of the present invention enables good utilization of limited space and convenient maintenance at reduced cost, and is therefore novel, improved, and practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A hinge mechanism for motor vehicle, comprising:
a base being provided on one side with parallelly extended first and second brackets;
a supporting arm having a proximal end extended into a space between the first and the second bracket of the base; the proximal end of the supporting arm being provided with at least one shaft hole, and the at least one shaft hole being provided with a diametrically extended stop rib;
a pivot shaft transversely extended through a middle section of the first and the second bracket of the base, and being provided on at least a second end corresponding to the second bracket with an inward longitudinally extended slot for engaging with the stop rib formed on the supporting arm, so that the pivot shaft is connected to and rotatable along with the supporting arm;
a restoring spring located at an outer side of the first bracket with an outer end and an inner end respectively connected to the base and a first end of the pivot shaft corresponding to the first bracket, and being able to produce an elastic restoring force when becoming deformed; and
a damper fixedly mounted to an outer side of the second bracket opposite to the restoring spring, and being connected at a central point to the second end of the pivot shaft to form a resistance to the pivot shaft when the pivot shaft is rotated.

2. The hinge mechanism for motor vehicle as claimed in claim 1, wherein the supporting arm includes at least three sequentially connected sections, namely, an extension section, a bent section, and an inclined section; and the inclined section being provided at a free end thereof with a mounting plate, and the at least one shaft hole being provided at a free end of the extension section.

3. The hinge mechanism for motor vehicle as claimed in claim 1, wherein the supporting arm is provided on one of two side walls with a movable adjusting element to interfere with one of the two brackets.

4. The hinge mechanism for motor vehicle as claimed in claim 1, wherein the pivot shaft is provided around the at least one longitudinally extended slot with an annular groove for a C-ring to engage therewith.

5. The hinge mechanism for motor vehicle as claimed in claim 1, wherein the restoring spring is spirally wounded, and the outer end of the restoring spring being formed into a hook portion for hooking to a bottom of the base, and the inner end of the restoring spring being bent to form a flat portion for engaging with an inward longitudinally extended slot formed on the first end of the pivot shaft.

6. The hinge mechanism for motor vehicle as claimed in claim 1, wherein the damper is provided at a center with a round through hole, which has a diametrically extended stop rib for engaging with the longitudinal slot on the second end of the pivot shaft, and thereby connecting the damper to the pivot shaft.
